(19) United States
(12) Patent Application Publication
(10) Pub. No.: US 2013/0172005 A1
(43) Pub. Date: Jul. 4, 2013

(54) CALCULATING WI-FI ACCESS POINT LOCATIONS USING WAVE OF DISCOVERY

(71) Applicants: Keir Finlow-Bates, Kangasala (FI); Joonas Viskari, Lempaala (FI); Florean Curticapean, Tampere (FI)

(72) Inventors: Keir Finlow-Bates, Kangasala (FI); Joonas Viskari, Lempaala (FI); Florean Curticapean, Tampere (FI)

(73) Assignee: QUALCOMM ATHEROS Incorporated, San Jose, CA (US)

(21) Appl. No.: 13/342,457

(22) Filed: Jan. 3, 2012

(51) Int. Cl. H04W 24/00

(52) U.S. Cl. 455/456.1

(57) ABSTRACT

A wireless network having a plurality of access points that automatically share positional information with each other without using a central server is disclosed. Each access point includes processor to generate location information associated with the respective access point, a location table having a plurality of entries each for storing location information associated with a corresponding one of the plurality of access points, and a transmitter to automatically broadcast all location information stored in the location table to other visible access points in response to an update in one or more of the entries.

### TECHNICAL FIELD

The present embodiments relate generally to wireless communication, and specifically to determining locations of Wi-Fi access points and Wi-Fi enabled mobile devices.

### BACKGROUND OF RELATED ART

Modern navigation systems frequently use a global navigation satellite system (GNSS) for position determination. However, the recent proliferation of Wi-Fi access points in wireless local area networks (WLANs) has made it possible for navigation systems to use these access points for position determination, especially in areas where there is a large concentration of active Wi-Fi access points (e.g., urban cores, shopping centers, office buildings, and so on). Indeed, WLAN location and navigation systems can be advantageous over GPS location and navigation systems in certain environments because of GPS signal coverage limitations. For example, while GPS signals may not be readily detectable inside structures such as shopping malls and office buildings (e.g., due to signal attenuation and/or multipath effects), wireless signals generated by Wi-Fi access points located within such structures are typically detectable by each other and by a mobile communication device.

For WLAN navigation systems, the locations of the Wi-Fi access points are used as reference points from which well-known trilateration techniques can determine the location of a mobile device (e.g., a Wi-Fi-enabled cell phone, laptop, or tablet computer). More specifically, the mobile device can use the received signal strength indicators (RSSI) associated with a number of visible access points as indications of the distances between the mobile device and each of the detected access points, where a stronger RSSI means that the mobile device is closer to the access point and a weaker RSSI means that the mobile device is further from the access point. The mobile device can also use the round trip time (RTT) of signals transmitted to and from the access points to estimate the distances between the mobile device and the access points. Once these distances are estimated, the location of the mobile device relative to the access points can be determined using trilateration techniques.

Whether using RSSI or RTT techniques to determine the distances between the mobile device and the visible Wi-Fi access points, the precise geographic location (e.g., latitude and longitude) of at least three such access points needs to be known to establish the absolute location of the mobile device. A number of online location databases can be used to determine the locations of large numbers of actively deployed Wi-Fi access points according to their unique basic service set identifier (BSSID) values. For example, companies including Google, Skyhook, Devicescape, and WiGLE have built location databases of BSSID values and the geographic locations of their corresponding access points. Typically, the location of a particular access point is first determined either manually (e.g., using electronic mapping) or using the access point's embedded GPS capabilities, and then the access point's location is uploaded (along with the access point's BSSID value) to the location database. Thereafter, a mobile device can determine the precise location of a selected visible access point by obtaining the BSSID from the access point, providing the BSSID to the location database, and then receiving the access point's location coordinates from the location database.

However, in some environments, the precise location of some access points associated with a particular WLAN may not be known. For example, when establishing or expanding a WLAN within an office building or a shopping mall, some of the access points may not have sufficient line-of-sight with the GPS satellites to independently determine their own location coordinates, and therefore are unable to upload their location coordinates to any access point location databases. Conventional solutions to this problem typically involve manual techniques in which a technician determines a number (e.g., 3 or more) of fixed locations within or around the WLAN, manually measures the exact distances between a selected access point and the fixed locations, and then uses trilateration techniques to calculate the precise location of the selected access point. This process is then repeated for each access point whose precise location is not known.

Although effective in determining the location coordinates of a number of access points associated with a WLAN, such manual techniques are time consuming and expensive (e.g., in terms of man power). Thus, there is a need for the access points associated with a WLAN to be able to automatically determine their own locations without using the manual techniques described above.

### BRIEF DESCRIPTION OF THE DRAWINGS

The present embodiments are illustrated by way of example and are not intended to be limited by the figures of the accompanying drawings, where:

FIG. 1 is a block diagram of a WLAN within which the present embodiments can be implemented;

FIG. 2A illustrates how the relative position of a point can be determined with respect to one wireless access point;

FIG. 2B illustrates how the relative position of a point can be determined with respect to two wireless access points;

FIG. 2C illustrates how the relative position of a point can be determined with respect to three wireless access points;

FIG. 3 is a block diagram of a respective one of the wireless access points of FIG. 1 in accordance with some embodiments;

FIG. 4 is a block diagram of the WLAN of FIG. 1 illustrating the broadcast ranges of the wireless access points;

FIG. 5A is a block diagram of the WLAN of FIG. 4 depicting access points AP1-AP7 prior to detecting one another and sharing location information;

FIG. 5B is a block diagram of the WLAN of FIG. 5A depicting access point AP2 sharing its location information with other directly visible access points AP1 and AP3-AP4 in accordance with some embodiments;

FIG. 5C is a block diagram of the WLAN of FIG. 5A depicting access points AP1 and AP3-AP4 sharing their location information with other directly visible access points in accordance with some embodiments;

FIG. 6A is a block diagram of the WLAN of FIG. 4 depicting access points AP1-AP3 as having known location coordinates and depicting access points AP4-AP7 as having unknown location coordinates;

FIG. 6B is a block diagram of the WLAN of FIG. 6A depicting access points AP1-AP3 sharing their location information with other directly visible access points in accordance with some embodiments;

FIG. 6C is a block diagram of the WLAN of FIG. 6A depicting access point AP4 sharing its location information with other directly visible access points in accordance with some embodiments; and

FIG. 7 is an illustrative flow chart depicting an exemplary operation for sharing location information across a plurality of access points using iterative waves of broadcasting operations in accordance with some embodiments.

Like reference numerals refer to corresponding parts throughout the drawing figures.

### DETAILED DESCRIPTION

In accordance with the present embodiments, accurate position capability can be provided using a Wireless Local Area Network (WLAN). As used herein, the term WLAN can include communications governed by the IEEE 802.11 standards, Bluetooth, HiperLAN (a set of wireless standards, comparable to the IEEE 802.11 standard, used primarily in Europe), and other technologies having relatively short radio propagation range. In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components. The present embodiments are not to be construed as limited to specific examples described herein but rather to include within their scopes all embodiments defined by the appended claims.

As mentioned above, the precise location of some (or all) access points associated with a particular WLAN may not be known. For example, when establishing or expanding a WLAN within an office building or shopping mall, some of the access points may not have sufficient line-of-sight with the GPS satellites to independently determine their own location coordinates, and therefore are unable to upload their location coordinates to any access point location databases. Rather than rely upon manual techniques that use surveying to determine the precise location of each access point and then program each location into the corresponding access point, the present embodiments allow for location information to be automatically shared between a plurality of access points forming a WLAN by configuring each access point to broadcast its location information to all visible access points in response to (1) determining and/or updating its own location information and/or (2) receiving location information from another access point in the WLAN. Thus, for some embodiments, location information stored in and/or calculated by a selected access point can be shared with other non-visible access points in the WLAN by first broadcasting the location information from the selected access point to a first set of access points that are visible to the selected access point, re-broadcasting the location information from the first set of access points to a second set of access points that are visible to the first set of access points, and so on, until the location information has been iteratively broadcast to all the access points in the WLAN. In this manner, the present embodiments allow the access points to iteratively share location information updates across the WLAN without using a central server.

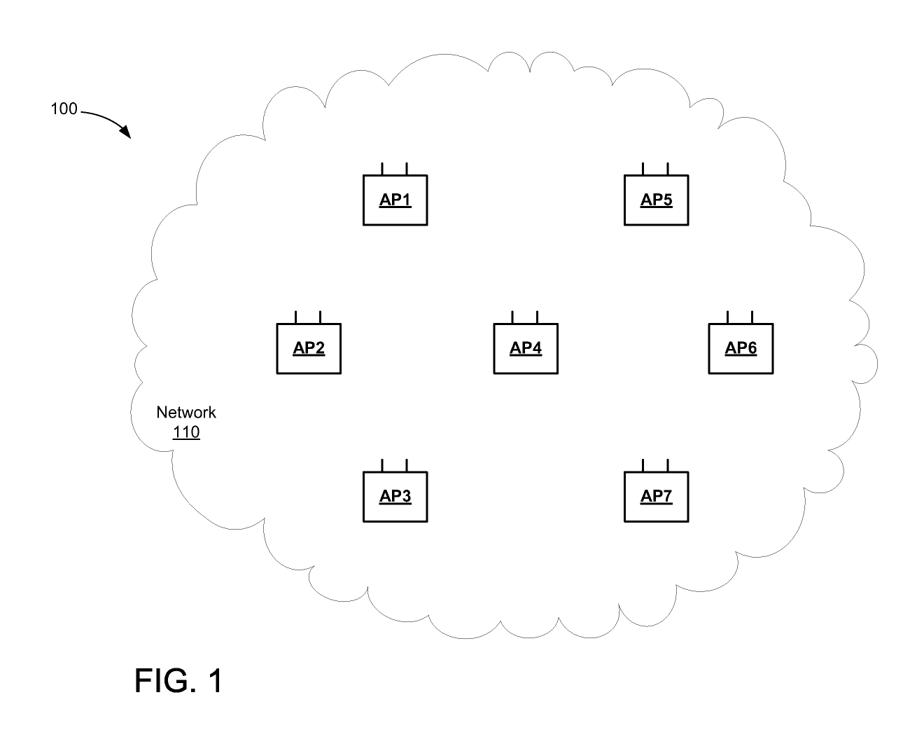

FIG. 1 is a block diagram of an exemplary system 100 within which the present embodiments can be implemented. System 100 is shown to include a plurality of WLAN access points AP1-AP7 that collectively form a WLAN 110. The access points AP1-AP7, which can operate according to the IEEE 802.11 family of standards (or according to other suitable wireless protocols), are each assigned a unique MAC address (i.e., MAC1-MAC7, respectively) that is programmed therein by, for example, the manufacturer of the access point. Each MAC address, which may be commonly referred to as the “burned-in address,” the organizationally unique identifier (OUI), or the BSSID, in one embodiment includes six bytes of data. The first 3 bytes of the MAC address may identify which organization manufactured the access point device (e.g., whether the AP is made by Cisco Systems, Inc.), and may be assigned to such organizations by the Institute of Electrical and Electronic Engineers (IEEE). The second 3 bytes of the MAC address, which may be referred to as the network interface controller (NIC) specific bytes, may be used to uniquely identify the individual access point device.

For the embodiments described herein, each of access points AP1-AP7 includes radio frequency (RF) ranging circuitry (e.g., formed using well-known software modules, hardware components, and/or a suitable combination thereof) that can be used to estimate the distance between itself and one or more other visible access points using suitable ranging techniques. For example, each of access points AP1-AP7 can use received signal strength indicator (RSSI) and/or round trip time (RTT) techniques to estimate the distance between itself and another visible access point, for example, by correlating each RSSI or RTT value with a distance. Further, for the embodiments described herein, each of access points AP1-AP7 also includes a processor (e.g., formed using well-known software modules, hardware components, and/or a suitable combination thereof) that can use the estimated distances between itself and a plurality of other access points to calculate its position relative to the other access points using trilateration techniques.

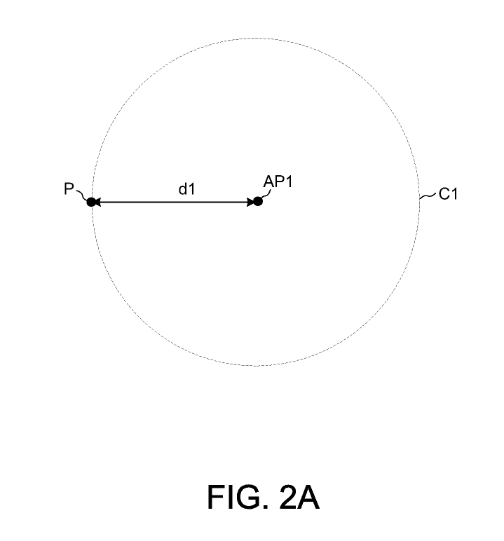

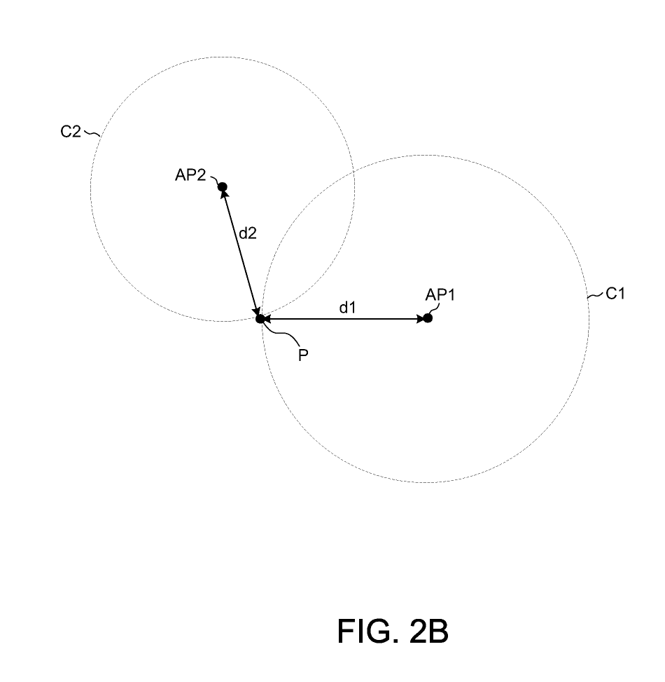

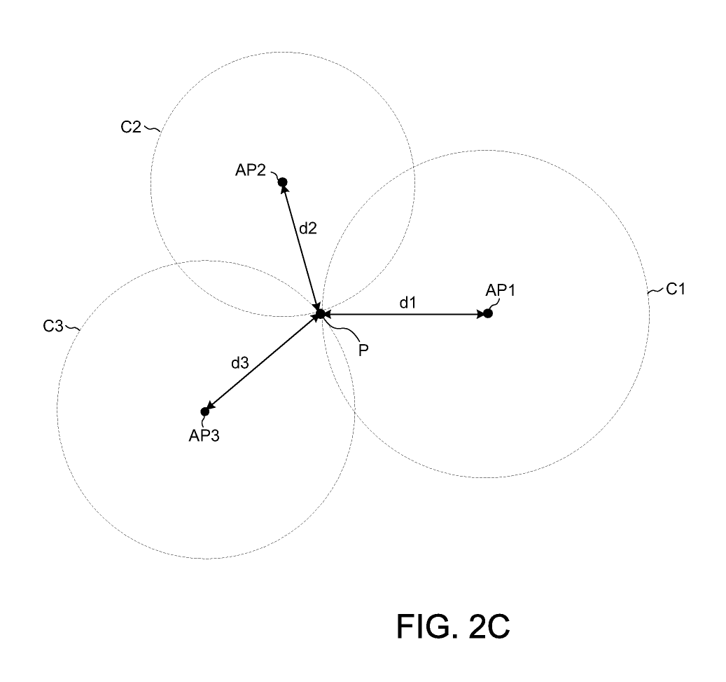

To accurately determine the position of a selected access point relative to other visible access points using trilateration techniques, the distances between the selected access point and at least 3 other access points are used. For example, as depicted in FIG. 2A, knowing the distance (d1) between a point (P) and one access point AP1 provides ranging information but not positional information because the point P could possibly lie anywhere on a circle C1 centered at AP1 and having a radius R1=d1. If the distance (d2) between a second access point AP2 and point P can also be determined, then the relative position of point P can be narrowed to the two locations where circle C1 intersects a circle C2 centered at AP2 and having a radius R2=d2, as depicted in FIG. 2B. Finally, if the distance (d3) between a third access point AP3 and point P can also be determined, then the relative position of point P can be narrowed to the single location where circles C1, C2, and C3 intersect, as depicted in FIG. 2C, where circle C3 is centered at AP3 and has a radius R3=d3. Indeed, once the distances between the point P and three access points AP1-AP3 are known, then the relative position of point P with respect to AP1-AP3 can be calculated using suitable trilateration techniques. For some embodiments, trilateration techniques disclosed in commonly owned U.S. Pat. No. 7,899,472, the entirety of which is incorporated by reference herein, can be used. For example, as disclosed in U.S. Pat. No. 7,899,472, if the known position of AP1 is (x1, y1, z1), the known position of AP2 is (x2, y2, z2), and the known position of AP3 is (x3, y3, z3), then computing the coordinate position of point P as (x0, y0, z0) includes using a set of equations:

x0=(w1*x1)+(w2*x2)+(w3*x3)

y0=(w1*y1)+(w2*y2)+(w3*y3), and

z0=(w1*z1)+(w2*z2)+(w3*z3),

wherein

w1=(1/d1)/(1/d1+1/d2+1/d3),

w2=(1/d2)/(1/d1+1/d2+1/d3), and

w3=(1/d3)/(1/d1+1/d2+1/d3).

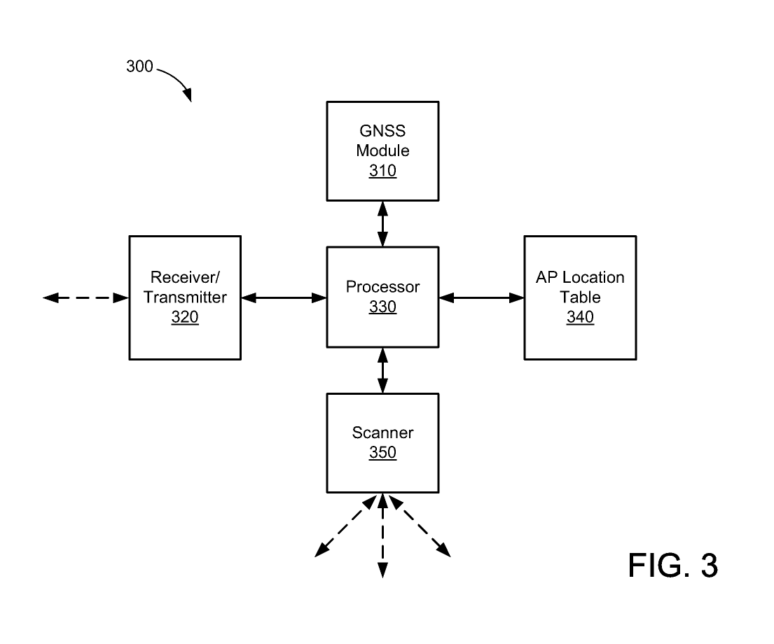

In accordance with the present embodiments, access points AP1-AP7 of WLAN 110 each include a location table that stores location information for all access points AP1-AP7 in WLAN 110 as well as the estimated distances between pairs of AP1-AP7. More specifically, FIG. 3 is a block diagram of an access point 300 that is one embodiment of access points AP1-AP7 of FIG. 1. Access point 300 is shown to include a global navigation satellite system (GNSS) module 310, a transmitter/receiver circuit 320, processor 330, an access point location table 340, and a scanner 350. The receiver/transmitter circuit 320 can be used to transmit signals to and receive signals from other access points and/or one or more mobile communication devices (not shown for simplicity) associated with the network. Referring also to FIG. 1, the location table 340, which can be any suitable memory element or device (e.g., EPROM, EEPROM, Flash memory, and so on), can be used to store the distances between each pair of access points AP1-AP7, the location coordinates (e.g., the absolute location) of access points AP1-AP7, the MAC addresses of access points AP1-AP7, and other suitable location or position information. Scanner 350, which is well-known, can be used to scan the environment surrounding access point 300 to detect and identify other nearby access points. If the access point 300 has a suitable line-of-sight with 3 or more GPS navigation satellites, the GNSS module 310 can determine the current location of access point 300 using well-known techniques, and then provide the location information to processor 330 for storage in the location table 340. Processor 330, which is coupled to receiver/transmitter 320, GNSS module 310, location table 340, and scanner 350, can be any suitable processor capable of executing scripts or instructions of one or more software programs stored in an associated memory (not shown for simplicity).

For some embodiments, the scanner 350 can search for nearby access points by periodically transmitting MAC address request frames. A neighboring access point within range of access point 300 receives one or more of the requests and can respond by transmitting its MAC address to the access point 300. Once the nearby access point is detected, processor 330 can use the receiver/transmitter circuit 320 to perform RF ranging operations (e.g., using RSSI and/or RTT techniques) to estimate the distance between itself and the other access point. Of course, if the other access point knows its own location coordinates, then it can transmit its location coordinates to access point 300 for storage in the location table 340.

An exemplary format for one embodiment of the location table 340 associated with access point 300 is shown below in Table 1. The location table shown in Table 1 below includes a plurality of row entries, each for a corresponding one of the access points AP1-AP7 associated with the WLAN 110 of FIG. 1. More specifically, each row entry includes an access point field to store the name of the associated access point, a BSSID field to store the MAC address of the access point, a number of distance fields to store the estimated distances between the access point and other access points in the WLAN, and a coordinate field to store the location coordinates of the access point. Note that dashes (“-”) are inserted in distance fields sharing the same access point. For example, because the distance between AP1 and itself is zero, a “-” is entered in the “Dist:AP1” field of the entry for the first access point AP1. Similarly, because the distance between AP2 and itself is zero, a “-” is entered in the “Dist:AP2” field of the entry for the second access point AP2, because the distance between AP3 and itself is zero, a “-” is entered in the “Dist:AP3” field of the entry for the third access point AP3, and so on.

TABLE 1

| | | | | | | | | | Loca- |
|---|---|---|---|---|---|---|---|---|---|
| | | | | | | | | | tion |
| | | Dist: | Dist: | Dist: | Dist: | Dist: | Dist: | Dist: | coor- |
| | BSSID | AP1 | AP2 | AP3 | AP4 | AP5 | AP6 | AP7 | dinates |
| AP1 | MAC1 | — | | | | | | | |
| AP2 | MAC2 | | — | | | | | | |
| AP3 | MAC3 | | | — | | | | | |
| AP4 | MAC4 | | | | — | | | | |
| AP5 | MAC5 | | | | | — | | | |
| AP6 | MAC6 | | | | | | — | | |
| AP7 | MAC7 | | | | | | | — | |

It is to be noted that the row entries in Table 1 are first created for other access points that are visible to the access point 300, and then additional row entries for other non-visible access points can be created in response to other access points sharing their location information with access point 300, as will be discussed in greater detail below.

Referring again to FIG. 1, if the access points AP1-AP7 include functional GNSS modules (e.g., GNSS module 310 of FIG. 3) and have an acceptable line-of-sight with GPS navigation satellites, then the access points AP1-AP7 can determine their own location coordinates using GPS triangulation techniques. However, if the access points AP1-AP7 either (1) do not include functional GNSS modules or (2) do not have an acceptable line-of-sight with GPS navigation satellites, then the access points AP1-AP7 can not determine their own location coordinates using GPS triangulation techniques. In this case, RF ranging techniques can be used to estimate the distances between pairs of visible access points AP1-AP7, and then the estimated distances can be used to determine the positions of access points AP1-AP7 relative to one another. Unfortunately, knowing the relative positions of the access points AP1-AP7 may not be sufficient to provide accurate location-based services (e.g., mapping, directions, and so on). Indeed, knowing the precise location coordinates of access points AP1-AP7 can be essential to provide such location-based services.

One common situation in which a number of access points associated with a WLAN do not know their own location coordinates arises when a WLAN is initially deployed in a building or other structure that obscures GPS signals (e.g., thus preventing such signals from being received by the access points associated with the WLAN). For example, referring again to FIG. 1, assume that none of access points AP1-AP7 have access to GPS positioning signals, and therefore none of access points AP1-AP7 can determine their own locations using GPS techniques. As mentioned above, conventional approaches for determining the precise location coordinates for all access points AP1-AP7 associated with WLAN 110 typically include manually surveying the entire space of WLAN 110 to determine the location coordinates of each access point AP1-AP7, and then programming each set of location coordinates into a corresponding one of access points AP1-AP7. Although effective, such manual techniques can be time consuming and expensive (e.g., in terms of manpower) to map all the access points in the WLAN, particularly when modern WLAN systems can include hundreds of access points, new access points can be added, existing access points can be deleted, and/or existing access points can be moved.

Thus, in accordance with the present embodiments, each of the access points AP1-AP7 can be configured to automatically detect the presence of other visible access points, to estimate the distances between itself and each of the other visible access points, to calculate its position relative to the other visible access points, and (if possible) to determine or calculate its own location coordinates. In addition, each access point can be configured to store the estimated distances between itself and the other visible access points, its position relative to the other visible access points, and its own location coordinates (if available) as a location information entry into its own location table 340. Further, in accordance with the present embodiments, each of access points AP1-AP7 can be configured to broadcast all location information entries within its location table 340 to all other visible access points. For some embodiments, each access point can broadcast its location table to the other visible access points in response to receiving or detecting an updated field entry of the access point location table 340. For other embodiments, each access point can broadcast its location table to the other visible access points periodically (e.g., according to a broadcast schedule). Then, each of the visible access points that receives the broadcasted location table can (1) update its own location table with any new or modified field entries and (2) broadcast its own updated location table to its set of visible access points. This process can be repeated in multiple phases or waves until all access points in the WLAN have been updated with the most current location information, thereby allowing the location coordinates of sequential sets of access points in the WLAN to be automatically calculated in an iterative fashion.

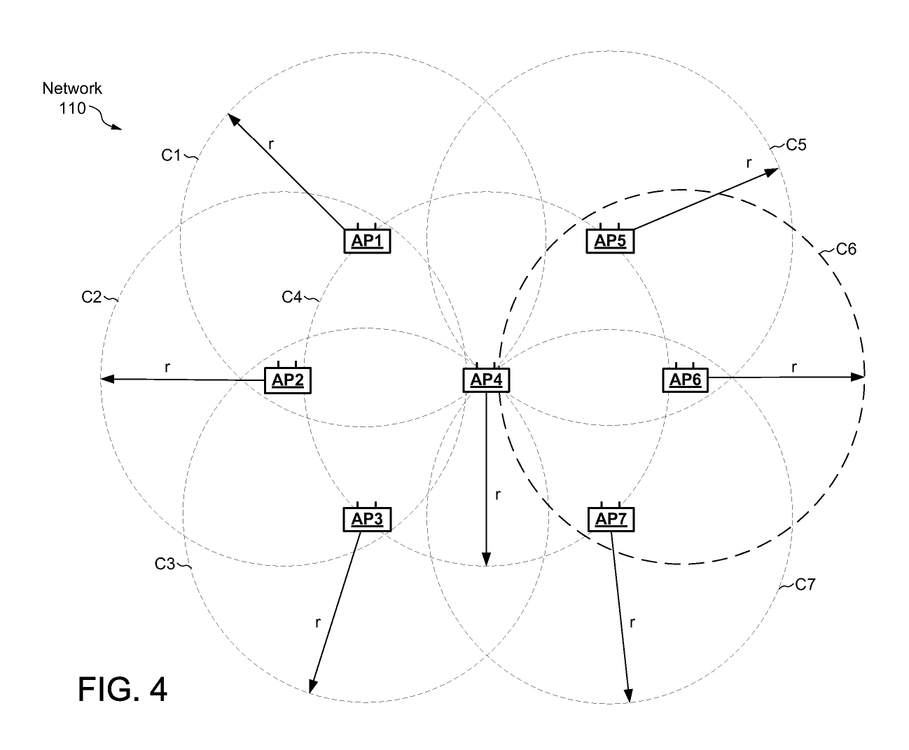

It is noted that in a network such as WLAN 110 of FIG. 1, each of access points AP1-AP7 has a limited broadcast range, and therefore not all access points in the WLAN 110 may be visible to a particular access point. For example, FIG. 4 depicts broadcast ranges for access points AP1-AP7 as a set of corresponding circles C1-C7 each having a radius (r) and centered upon a respective one of access points AP1-AP7. For example, AP2 has a range depicted by circle C2 that encompasses other access points AP1, AP3, and AP4. Accordingly, access points AP1, AP3, and AP4 are directly visible to AP2, while access points AP5, AP6, and AP7 are not directly visible to AP2. Note, however, that access points AP5, AP6, and AP7 are directly visible to AP4 because they lie within the range of AP4 depicted by circle C4. Thus, conventional techniques are typically not able to share location information stored in AP2 with non-visible access points AP5, AP6, and AP7 without using a central server interconnected between all access points AP1-AP7.

However, in accordance with the present embodiments, location information stored in and/or calculated by a selected access point can be shared with other non-visible access points by first broadcasting the location information from the selected access point to a first set of access points that are visible to the selected access point, then re-broadcasting the location information from the first set of access points to a second set of access points that are visible to the first set of access points, and so on, until the location information has been iteratively shared with all the access points in the WLAN (e.g., in an ad-hoc or peer-to-peer manner). For example, location information stored in and/or calculated by AP2 can be shared with AP6 by first broadcasting the location information from AP2 to AP4, and then broadcasting the location information from AP4 to AP6. In this manner, each access point in WLAN 110 can be configured to automatically broadcast its stored location information to other visible access points when either (1) the access point determines or calculates new location information or (2) new location information is received from another access point, thereby allowing the access points to share location information updates across the WLAN without using a central server.

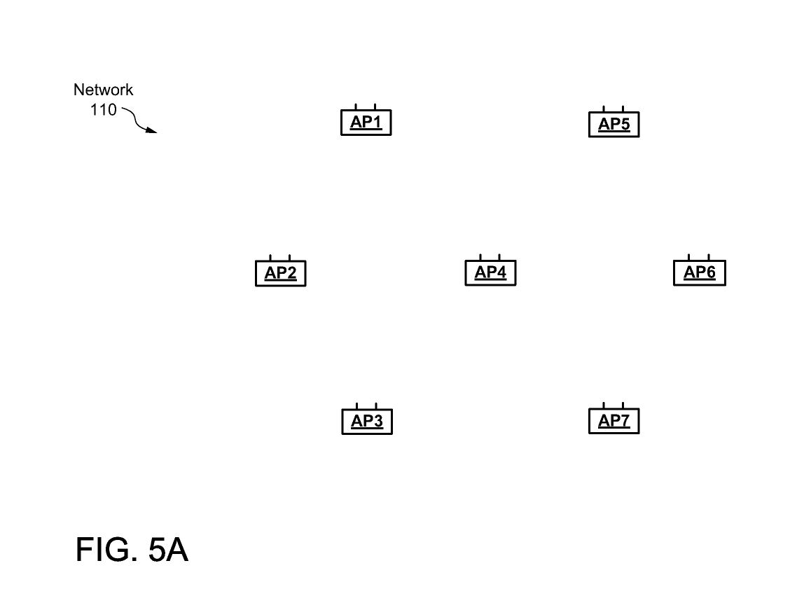

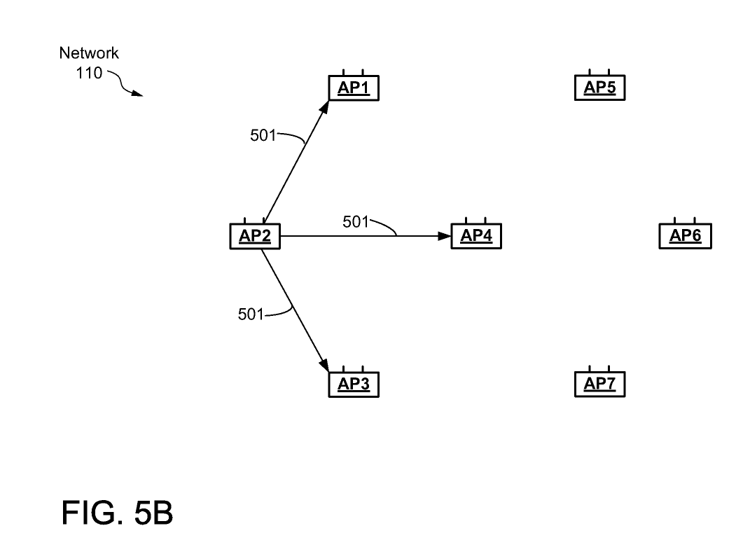

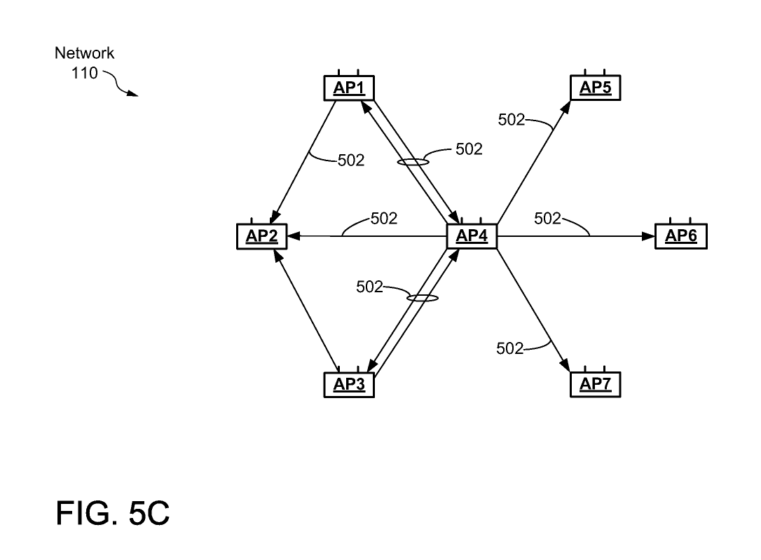

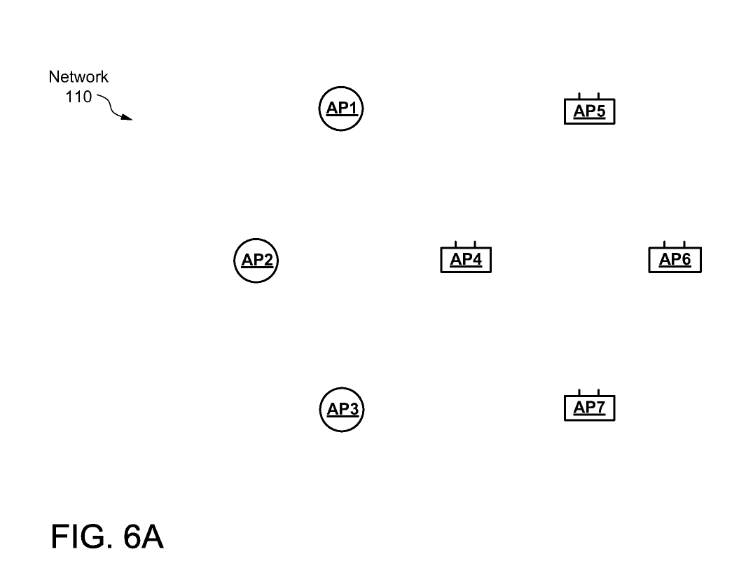

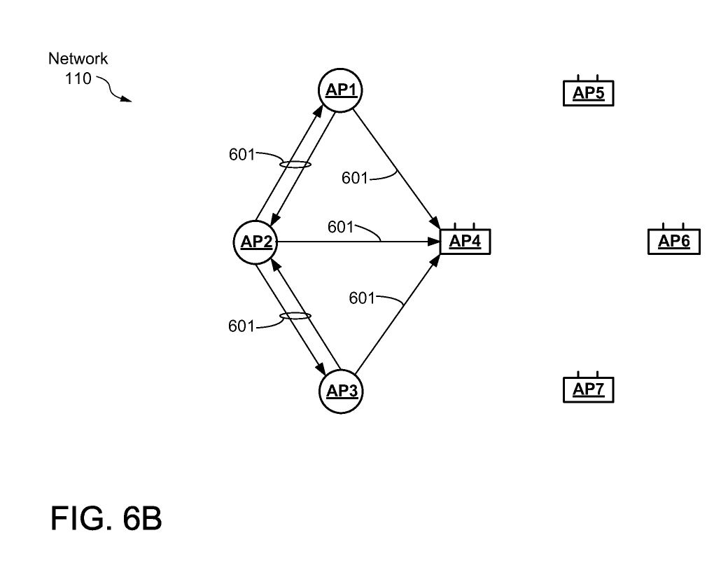

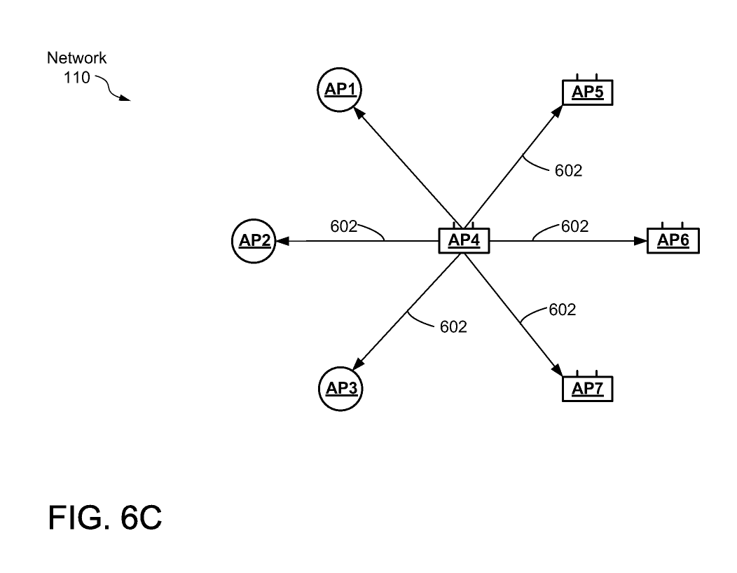

A more detailed operation for determining and sharing location information in the WLAN 110 of FIGS. 1 and 4 is described below with respect to FIGS. 5A-5C and FIGS. 6A-6C. Referring to FIG. 5A, initially, the location coordinates of none of access points AP1-AP7 are known, and none of the access points AP1-AP7 has performed ranging operations to estimate the distance between itself and other directly visible access points. Thus, each of access points AP1-AP7 initially stores an empty location table (e.g., as depicted in Table 1 above), and has not shared any location information with other access points. It is noted that, for each given access point in WLAN 110, the associated location table 340 initially has entries corresponding only to those access points that are directly visible to the given access point (e.g., because the given access point cannot detect other access points that are not directly visible). Of course, in accordance with the present embodiments, location entries for those other non-visible access points can be created after the access points in the WLAN share their own and other's location information with each other, as discussed in detail below.

Once the access points AP1-AP7 are initialized and operational, each of access points AP1-AP7 detects other visible access points and can begin using RF ranging techniques to estimate the distance between itself and the other visible access points. For illustrative purposes, the location table 340 associated with AP2 is selected for discussion herein. More specifically, Table 2 below depicts the initial location table 340 stored in AP2 after AP2 estimates the distances between itself and visible access points AP1, AP3, and AP4 using well-known RSSI and/or RTT ranging techniques. Note that because access points AP5-AP7 are not directly visible to AP2 and therefore are not directly detected, the location table associated with AP2 shown below in Table 2 does not initially include entries for the non-visible access points AP5-AP7. It is noted that although this discussion focuses upon AP2, all other access points AP1 and AP3-AP7 can begin detecting other visible access points and can commerce their own ranging operations concurrently with ranging operations performed by AP2.

TABLE 2

| | | Dist: | Dist: | Dist: | Dist: | Location |
|---|---|---|---|---|---|---|
| | BSSID | AP1 | AP2 | AP3 | AP4 | coordinates |
| AP1 | MAC1 | — | 4 | | | |
| AP2 | MAC2 | 4 | — | 4 | 6 | |
| AP3 | MAC3 | | 4 | — | | |
| AP4 | MAC4 | | 6 | | — | |

Once AP2 has estimated the above distances, AP2 shares (e.g., broadcasts) information stored in its location table with the set of visible access points AP1 and AP3-AP4, as depicted in FIG. 5B by broadcast signals 501. For some embodiments, AP2 broadcasts its location information to all other visible access points in response to detecting new location information rather than in response to receiving a probe or request signal from another access point. Upon receiving the location information broadcast by AP2, each of access points AP1 and AP3-AP4 updates the location information stored in their own location tables with the information broadcast by AP2, and then each of access points AP1 and AP3-AP4 shares (e.g., broadcasts) information stored in its location table to all access points visible thereto, as depicted by broadcast signals 502 in FIG. 5C. In this manner, ranging information determined by AP1 and AP3-AP4 is shared with each other and with AP2. For example, because access points AP5-AP7 are directly visible to AP4 but not directly visible to AP1-AP3, AP4 can inform AP1-AP3 that it has detected the existence of AP5-AP7, and can share (e.g., broadcast) estimated distances between AP4 and each of AP5-AP7 with AP1-AP3. Thereafter, each of AP1-AP3 can update their location table with new entries for AP5-AP7 and with the location information broadcast by AP4. Thus, the location table 340 for AP2 is updated to include the information shown below in Table 3.

TABLE 3

| | | | | | | | | | Loca- |
|---|---|---|---|---|---|---|---|---|---|
| | | | | | | | | | tion |
| | | Dist: | Dist: | Dist: | Dist: | Dist: | Dist: | Dist: | coor- |
| | BSSID | AP1 | AP2 | AP3 | AP4 | AP5 | AP6 | AP7 | dinates |
| AP1 | MAC1 | — | 4 | | 5 | | | | |
| AP2 | MAC2 | 4 | — | 4 | 6 | | | | |
| AP3 | MAC3 | | 4 | — | 5 | | | | |
| AP4 | MAC4 | 5 | 6 | 5 | — | 5 | 6 | 5 | |
| AP5 | MAC5 | | | | 5 | — | 4 | | |
| AP6 | MAC6 | | | | 6 | 4 | — | 4 | |
| AP7 | MAC7 | | | | 5 | | 4 | — | |

This process is repeated in an iterative manner until all the currently available location information has been shared by all the access points AP1-AP7.

Now, assume that the location coordinates of selected access points AP1-AP3 are determined and stored in the location table 340 within corresponding access points AP1-AP3. The location coordinates of the selected access points can be determined using any suitable techniques (e.g., manually surveying AP1-AP3, using GPS techniques if satellite signals are available, and so on). The location coordinates for AP1 are expressed herein as (x1, y1, z1), the location coordinates for AP2 are expressed herein as (x2, y2, z2), and the location coordinates for AP3 are expressed herein as (x3, y3, z3). For example, FIG. 6A depicts WLAN 110 after the location coordinates of AP1-AP3 are determined and stored within the location table 340 of each respective access point AP1-AP3, where AP1-AP3 having known locations are represented as circles and AP4-AP7 having unknown locations are represented as rectangles.

In accordance with the present embodiments, each of selected access points AP1-AP3 shares its own set of location coordinates with all other visible access points in the manner described above (e.g., via broadcasting). Then, the other visible access points update their location tables with the newly acquired location coordinates for AP1-AP3, and then each of the other visible access points shares the new location information with all other access points visible thereto. Thus, for the present example, AP1-AP3 share their own location coordinates with other and with visible access point AP4 by broadcasting such information to their visible access points, as depicted by broadcast signals 601 in FIG. 6B. In response thereto, AP4 shares the location coordinates of AP1-AP3 (and any other location information already stored in the location table 340 of AP4) with visible access points AP1-AP3 and AP5-AP7 by broadcasting such information to its visible access points, as depicted by broadcast signals 602 in FIG. 6C. In this manner, the location coordinates of AP1-AP3 are shared with all other access points in WLAN 110 (e.g., including AP5-AP7 that are not directly visible to AP1-AP3) by iteratively broadcasting the location coordinates from a current set of visible access points to a next set of visible access points. Accordingly, the location table 340 for all access points AP1-AP7 now includes the location coordinates of AP1-AP3, as indicated in Table 4 below.

TABLE 4

| | | | | | | | | | Loca- |
|---|---|---|---|---|---|---|---|---|---|
| | | | | | | | | | tion |
| | | Dist: | Dist: | Dist: | Dist: | Dist: | Dist: | Dist: | coor- |
| | BSSID | AP1 | AP2 | AP3 | AP4 | AP5 | AP6 | AP7 | dinates |
| AP1 | MAC1 | — | 4 | | 5 | | | | x1, y1, |
| | | | | | | | | | z1 |
| AP2 | MAC2 | 4 | — | 4 | 6 | | | | x2, y2, |
| | | | | | | | | | z2 |
| AP3 | MAC3 | | 4 | — | 5 | | | | x3, y3, |
| | | | | | | | | | z3 |
| AP4 | MAC4 | 5 | 6 | 5 | — | 5 | 6 | 5 | |
| AP5 | MAC5 | | | | 5 | — | 4 | | |
| AP6 | MAC6 | | | | 6 | 4 | — | 4 | |
| AP7 | MAC7 | | | | 5 | | 4 | — | |

Further, because the location coordinates of AP1-AP3 are now also known to AP4, AP4 can use the distances between itself and each of AP1-AP3 and the location coordinates of each of AP1-AP3 to calculate its own location coordinates using trilateration techniques. Next, AP4 broadcasts its own location coordinates to AP1-AP3 and to AP5-AP7. Now, the location table 340 stored within each of access points AP1-AP7 now includes the location coordinates of AP4, as indicated in Table 5 below.

TABLE 5

| | | | | | | | | | Loca- |
|---|---|---|---|---|---|---|---|---|---|
| | | | | | | | | | tion |
| | | Dist: | Dist: | Dist: | Dist: | Dist: | Dist: | Dist: | coor- |
| | BSSID | AP1 | AP2 | AP3 | AP4 | AP5 | AP6 | AP7 | dinates |
| AP1 | MAC1 | — | 4 | 7 | 5 | | | | x1, y1, |
| | | | | | | | | | z1 |
| AP2 | MAC2 | 4 | — | 4 | 6 | | | | x2, y2, |
| | | | | | | | | | z2 |
| AP3 | MAC3 | 7 | 4 | — | 5 | | | | x3, y3, |
| | | | | | | | | | z3 |
| AP4 | MAC4 | 5 | 6 | 5 | — | 5 | 6 | 5 | x4, y4, |
| | | | | | | | | | z4 |
| AP5 | MAC5 | | | | 5 | — | 4 | | |
| AP6 | MAC6 | | | | 6 | 4 | — | 4 | |
| AP7 | MAC7 | | | | 5 | | 4 | — | |

The above-described process is repeated until all access points AP1-AP7 store the location coordinates of each other and the distances between each other, for example, as depicted below in Table 6.

TABLE 6

| | | | | | | | | | Loca- |
|---|---|---|---|---|---|---|---|---|---|
| | | | | | | | | | tion |
| | | Dist: | Dist: | Dist: | Dist: | Dist: | Dist: | Dist: | coor- |
| | BSSID | AP1 | AP2 | AP3 | AP4 | AP5 | AP6 | AP7 | dinates |
| AP1 | MAC1 | — | 4 | 7 | 5 | 7 | 10 | 10 | x1, y1, |
| | | | | | | | | | z1 |
| AP2 | MAC2 | 4 | — | 4 | 6 | 10 | 12 | 10 | x2, y2, |
| | | | | | | | | | z2 |
| AP3 | MAC3 | 7 | 4 | — | 5 | 10 | 10 | 7 | x3, y3, |
| | | | | | | | | | z3 |
| AP4 | MAC4 | 5 | 6 | 5 | — | 5 | 6 | 5 | x4, y4, |
| | | | | | | | | | z4 |
| AP5 | MAC5 | 7 | 10 | 10 | 5 | — | 4 | 7 | x5, y5, |
| | | | | | | | | | z5 |
| AP6 | MAC6 | 10 | 12 | 10 | 6 | 4 | — | 4 | x6, y6, |
| | | | | | | | | | z6 |
| AP7 | MAC7 | 10 | 10 | 7 | 5 | 7 | 4 | — | x7, y7, |
| | | | | | | | | | z7 |

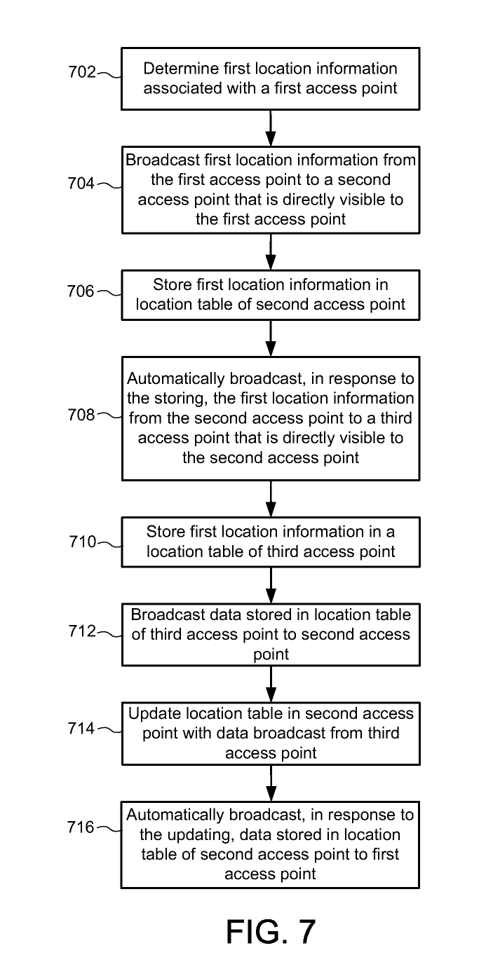

FIG. 7 is an illustrative flow chart depicting an exemplary operation for sharing location information among a plurality of access points in a WLAN. Initially, first location information associated with a first access point is determined and stored in the location table 340 of the first access point (702). Then, the first access point broadcasts the first location information to a second access point that is directly visible to the first access point (704). Next, the first location information is received in the second access point and stored in a location table provided therein (706). Then, in response to the receiving and/or storing, the first location information is automatically broadcast from the second access point to a third access point that is directly visible to the second access point (but which may not be directly visible to the first access point) (708).

Thereafter, the first location information is stored in a location table provided within the third access point (710). The data stored in the location table of the third access point can be updated or supplemented with other data receiving by the third access point and/or with location information determined by the third access point. Then, data stored in the location table of the third access point is broadcast to the second access point (712), the location table of the second access point is updated with the data broadcast by the third access point (714), and then, in response to the updating, data stored in the location table of the second access point is automatically broadcast to the first access point (716). In this manner, the access points of the WLAN can form a mesh to share ranging data and location information with each other in repeated broadcast waves (e.g., in a peer-to-peer manner).

Referring also to FIG. 3, functions associated with 702 can be performed by the processor 330 of the corresponding access point, functions associated with 704, 708, 712, and 714 can be performed by receiver/transmitter 320 of the corresponding access point, and functions associated with 706, 710, and 714 can be performed by the location table 340 of the corresponding access point.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. For example, WLANs having access points configured in accordance with the present embodiments can share location information with a mobile communication device that has become part of the WLAN and/or can use positioning data provided by the mobile communication device to determine the location coordinates of one or more of the access points.

What is claimed is:

1. A method for sharing location information across a wireless network having a plurality of access points, the method comprising:
determining first location information associated with a first access point;
broadcasting the first location information from the first access point to a second access point that is directly visible to the first access point;
storing the first location information in a location table provided within the second access point; and
automatically broadcasting, in response to the storing, the first location information from the second access point to a third access point that is directly visible to the second access point.

2. The method of claim 1, wherein the third access point is not directly visible to the first access point.

3. The method of claim 1, wherein the first location information is shared with the third access point without accessing a central server coupled to the access points.

4. The method of claim 1, wherein the first access point is to automatically broadcast the first location information in response to the first location information being stored in a location table provided within the first access point.

5. The method of claim 1, wherein the first location information comprises estimated distances between the first access point and other access points that are directly visible to the first access point.

6. The method of claim 5, wherein the first location information further comprises estimated distances between pairs of other access points.

7. The method of claim 1, wherein the first location information comprises location coordinates of the first access point and at least one other access point.

8. The method of claim 1, further comprising:
storing the first location information in a location table provided within the third access point;
broadcasting data stored in the location table of the third access point to the second access point;
updating data in the location table of the second access point with the data broadcast by the third access point; and
automatically broadcasting, in response to the updating, data stored in the location table of the second access point to the first access point.

9. A wireless network having a plurality of access points configured to automatically share positional information with each other, wherein a respective access point comprises:
a processor to generate location information associated with the respective access point;
a location table, coupled to the processor, having a plurality of entries each for storing location information associated with a corresponding one of the plurality of access points; and
a transmitter, coupled to the processor, to automatically broadcast all location information stored in the location table to other visible access points in response to an update in one or more of the entries.

10. The wireless network of claim 9, wherein the location information is shared with all the access points without accessing a central server connected to the access points.

11. The wireless network of claim 9, wherein a respective location information comprises estimated distances between the respective access point and a first set of other access points that are visible to the respective access point.

12. The wireless network of claim 9, wherein the respective location information further comprises estimated distances between pairs of other access points.

13. The wireless network of claim 9, wherein the respective location information comprises location coordinates of the respective access point and at least one other access point.

14. The wireless network of claim 9, wherein the respective access point is to automatically re-broadcast, to all other visible access points, any location information received from another access point.

15. A system for sharing location information across a wireless network having a plurality of access points, the system comprising:
means for determining first location information associated with a first access point;
means for broadcasting the first location information from the first access point to a second access point that is directly visible to the first access point;
means for receiving the first location information in the second access point; and
means for automatically broadcasting, in response to the receiving, the first location information from the second access point to a third access point that is directly visible to the second access point.

16. The system of claim 15, wherein the third access point is not directly visible to the first access point.

17. The system of claim 15, wherein the first location information is shared with the third access point without accessing a central server connected to the access points.

18. The system of claim 15, wherein the first access point is to automatically broadcast the first location information in response to the first location information being stored in a location table provided within the first access point.

19. The system of claim 15, wherein the first location information comprises estimated distances between the first access point and other access points that are directly visible to the first access point.

20. The system of claim 19, wherein the first location information further comprises estimated distances between pairs of other access points.

21. The system of claim 15, wherein the first location information comprises location coordinates of the first access point and at least one other access point.

22. The system of claim 15, further comprising:
means for storing the first location information in a location table provided within the third access point;
means for broadcasting data stored in the location table of the third access point to the second access point;
means for updating data in the location table of the second access point with the data broadcast by the third access point; and
means for automatically broadcasting, in response to the updating, data stored in the location table of the second access point to the first access point.
